(19) United States
(12) Patent Application Publication
(10) Pub. No.: US 2013/0297436 A1
(43) Pub. Date: Nov. 7, 2013

(54) Customer Value Scoring Based on Social Contact Information

(71) Applicant: Andreas Vogel, San Francisco, CA (US)

(72) Inventor: Andreas Vogel, San Francisco, CA (US)

(73) Assignee: SAP AG, Walldorf (DE)

(21) Appl. No.: 13/463,707

(22) Filed: May 3, 2012

(51) Int. Cl. G06Q 30/00

(52) U.S. Cl. 705/26.1

(57) ABSTRACT

Example systems and methods of customer value scoring based on social contact information are presented. In one example, a spending amount by a first user at an online commerce system is determined. Other users of the online commerce system that are affiliated with the first user are identified. A spending amount by each of the other users at the online commerce system is also determined. The spending amounts of the other users are weighted. A user value score for the first user is calculated based on the spending amount of the first user and weighted spending amounts of the other users.

### BACKGROUND

Businesses of all kinds and sizes have employed various methods for classifying or grouping current and prospective customers for a number of business reasons. Oftentimes termed “customer segmentation” or “market segmentation,” this classification process may help identify specific people as belonging in a particular group having one or more qualities that potentially make them a particularly valuable customer. By identifying one or more such groups, a business may target its advertising and promotional activities to these particular groups, possibly tailoring such activities in accordance with the nature of that group. The targeting of these activities may thus result in more efficient use of the activities by directing them to those groups of current or potential customers that may be the most receptive, responsive, and/or capable of forming, maintaining, or expanding a relationship with the business.

In some situations, a business may calculate a score for each of the potential and/or current customers based on any number of traits or characteristics of each person. The business may then associate a range of such scores with a particular customer or market segment or group. Examples of such scores are credit scores, which are employed by banks and other lending institutions to determine the relative creditworthiness of consumers. Another example is the value score employed by some utility companies to determine the relative value of that customer to the utility in comparison to others.

The specific characteristics or traits that are employed to determine a particular score are typically those that are considered relevant for a particular business or market. The characteristics may include, for example, demographic data, such as the age, gender, geographic location, educational background, work history, marital status, and current income level of the customer. Other data possibly employed in determining a value score may include the purchase history, credit history, personal preferences, and similar information associated with each customer of interest.

### BRIEF DESCRIPTION OF DRAWINGS

The present disclosure is illustrated by way of example and not limitation in the figures of the accompanying drawings, in which like references indicate similar elements and in which:

FIG. 1 is a block diagram of an example system having a client-server architecture for an enterprise application platform capable of employing the systems and methods described herein;

FIG. 2 is a block diagram of example applications and modules employable in the enterprise application platform of FIG. 1;

FIG. 3 is a block diagram of example modules utilized in the enterprise application platform of FIG. 1 for systems and methods of customer value scoring based on social contact information;

FIG. 4 is a flow diagram of an example method of generating a user value score for a user of an online commerce system;

FIG. 5 is a flow diagram illustrating an example method of calculating the user value score for a first user based on average spending amounts associated with the first user and other users affiliated with the first user;

FIG. 6 is a flow diagram illustrating an example method of calculating the user value score for a first user based on average spending amounts associated with, and interactions between, the first user and other users affiliated with the first user;

FIG. 7 is an example customer segmentation graph depicting numbers of users versus user value scores; and

FIG. 8 is a block diagram of a machine in the example form of a processing system within which may be executed a set of instructions for causing the machine to perform any one or more of the methodologies discussed herein.

### DETAILED DESCRIPTION

The description that follows includes illustrative systems, methods, techniques, instruction sequences, and computing machine program products that embody illustrative embodiments. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures, and techniques have not been shown in detail.

At least some of the embodiments described herein provide various techniques for generating a user or customer value score that, in one implementation, may be employed to divide a customer or market population into useful segments for advertising, promotional, and other commercial purposes. In the examples described below, a score for a particular person may be derived from information relating to both that person as well as other people affiliated with that person. Those affiliated with the person for whom a score is generated may be identified by way of social contact information. This social contact information may provide a stated connection between that person and others, such as by way of a social network or graph. In other examples, the contact information may be data describing communications or other interactions between the person and others, such as within an online commerce system. Further, the generated user value score for the user may take into account money spent by both the user and the affiliations of the user, and may also reflect the quantity and/or quality of the connection or interactions between the user and the affiliations. Other aspects of the embodiments discussed herein may be ascertained from the following detailed description.

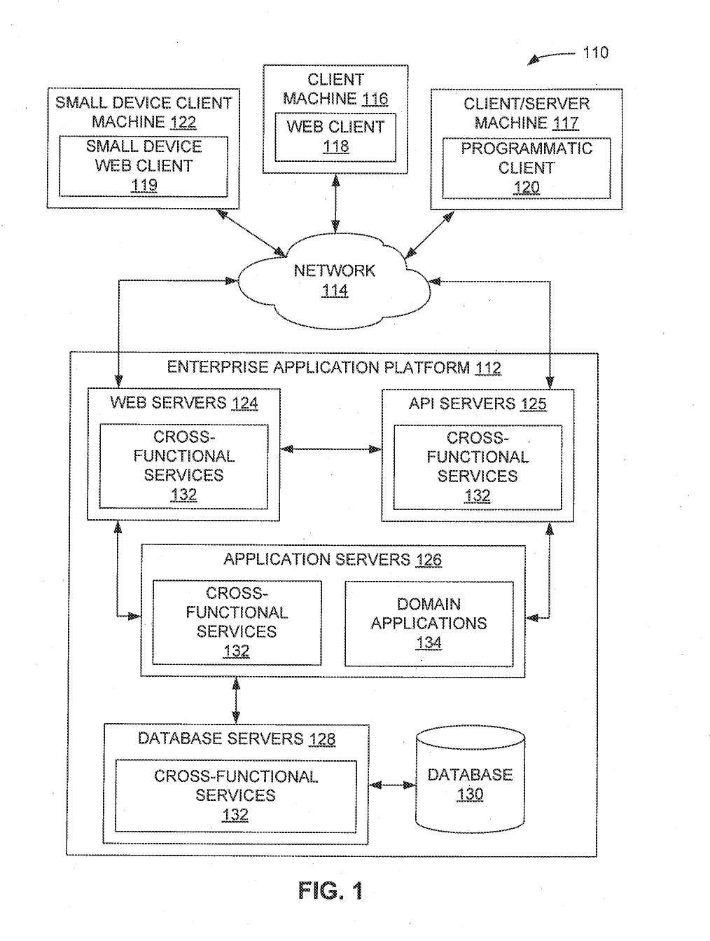

FIG. 1 is a network diagram depicting an example system 110, according to one exemplary embodiment, having a client-server architecture configured to perform the various methods described herein. A platform (e.g., machines and software), in the exemplary form of an enterprise application platform 112, provides server-side functionality via a network 114 (e.g., the Internet) to one or more clients. FIG. 1 illustrates, for example, a client machine 116 with a web client 118 (e.g., a browser, such as the Internet Explorer® browser developed by Microsoft Corporation), a small device client machine 122 with a small device web client 119 (e.g., a browser without a script engine), and a client/server machine 117 with a programmatic client 120.

Turning specifically to the enterprise application platform 112, web servers 124 and application program interface (API) servers 125 are coupled to, and provide web and programmatic interfaces to, application servers 126. The application servers 126 are, in turn, shown to be coupled to one or more database servers 128 that may facilitate access to one or more databases 130. The web servers 124, application program interface servers 125, application servers 126, and database servers 128 may host cross-functional services 132. The application servers 126 may further host domain applications 134.

The cross-functional services 132 may provide user services and processes that utilize the enterprise application platform 112. For example, the cross-functional services 132 may provide portal services (e.g., web services), database services, and connectivity to the domain applications 134 for users that operate the client machine 116, the client/server machine 117, and the small device client machine 122. In addition, the cross-functional services 132 may provide an environment for delivering enhancements to existing applications and for integrating third-party and legacy applications with existing cross-functional services 132 and domain applications 134. Further, while the system 110 shown in FIG. 1 employs a client-server architecture, the present disclosure is, of course, not limited to such an architecture, and could equally well find application in a distributed or peer-to-peer architecture system.

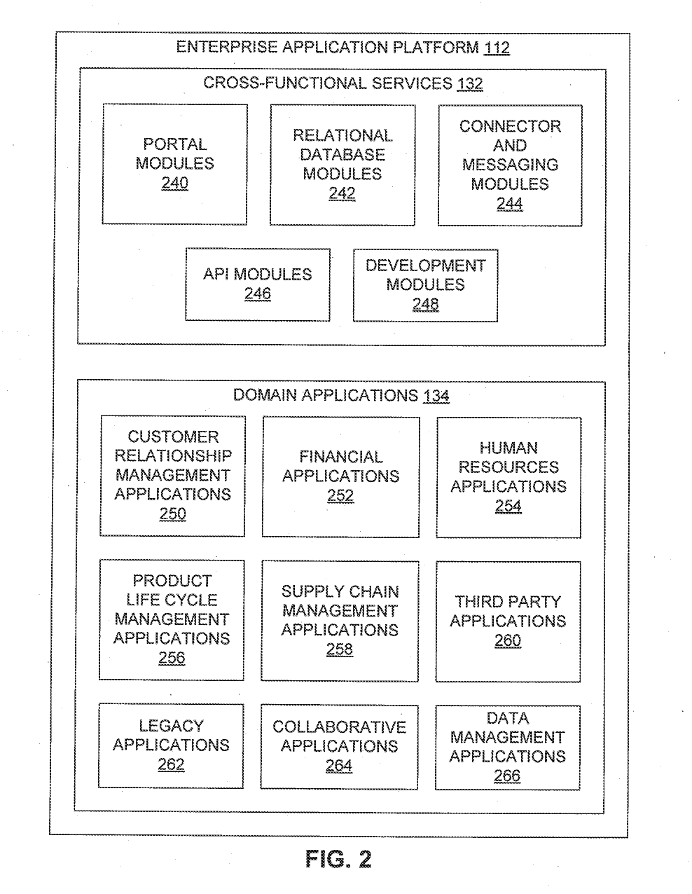

FIG. 2 is a block diagram illustrating example enterprise applications and services, such as those described herein, as embodied in the enterprise application platform 112, according to an exemplary embodiment. The enterprise application platform 112 includes cross-functional services 132 and domain applications 134. The cross-functional services 132 include portal modules 240, relational database modules 242, connector and messaging modules 244, application program interface (API) modules 246, and development modules 248.

The portal modules 240 may enable a single point of access to other cross-functional services 132 and domain applications 134 for the client machine 116, the small device client machine 122, and the client/server machine 117 of FIG. 1. The portal modules 240 may be utilized to process, author, and maintain web pages that present content (e.g., user interface elements and navigational controls) to the user. In addition, the portal modules 240 may enable user roles, a construct that associates a role with a specialized environment that is utilized by a user to execute tasks, utilize services, and exchange information with other users and within a defined scope. For example, the role may determine the content that is available to the user and the activities that the user may perform. The portal modules 240 may include, in one implementation, a generation module, a communication module, a receiving module, and a regenerating module. In addition, the portal modules 240 may comply with web services standards and/or utilize a variety of Internet technologies, including, but not limited to, Java®, J2EE, SAP's Advanced Business Application Programming (ABAP) Language and Web Dynpro, XML, JCA, JAAS, X.509, LDAP, WSDL, WSRR, SOAP, UDDI, and Microsoft .NET.

The relational database modules 242 may provide support services for access to the database 130 (FIG. 1) that includes a user interface library. The relational database modules 242 may provide support for object relational mapping, database independence, and distributed computing. The relational database modules 242 may be utilized to add, delete, update, and manage database elements. In addition, the relational database modules 242 may comply with database standards and/or utilize a variety of database technologies including, but not limited to, SQL, SQLDBC, Oracle, MySQL, Unicode, and JDBC.

The connector and messaging modules 244 may enable communication across different types of messaging systems that are utilized by the cross-functional services 132 and the domain applications 134 by providing a common messaging application processing interface. The connector and messaging modules 244 may enable asynchronous communication on the enterprise application platform 112.

The application program interface (API) modules 246 may enable the development of service-based applications by exposing an interface to existing and new applications as services. Repositories may be included in the platform 112 as a central place to find available services when building applications.

The development modules 248 may provide a development environment for the addition, integration, updating, and extension of software components on the enterprise application platform 112 without impacting existing cross-functional services 132 and domain applications 134.

Turning to the domain applications 134, customer relationship management applications 250 may enable access to, and facilitate collecting and storing of, relevant personalized information from multiple data sources and business processes. Enterprise personnel that are tasked with developing a buyer into a long-term customer may utilize the customer relationship management applications 250 to provide assistance to the buyer throughout a customer engagement cycle.

Enterprise personnel may utilize financial applications 252 and business processes to track and control financial transactions within the enterprise application platform 112. The financial applications 252 may facilitate the execution of operational, analytical, and collaborative tasks that are associated with financial management. Specifically, the financial applications 252 may enable the performance of tasks related to financial accountability, planning, forecasting, and managing the cost of finance.

Human resources applications 254 may be utilized by enterprise personnel and business processes to manage, deploy, and track enterprise personnel. Specifically, the human resources applications 254 may enable the analysis of human resource issues and facilitate human resource decisions based on real-time information.

Product life cycle management applications 256 may enable the management of a product throughout the life cycle of the product. For example, the product life cycle management applications 256 may enable collaborative engineering, custom product development, project management, asset management, and quality management among business partners.

Supply chain management applications 258 may enable monitoring of performances that are observed in supply chains. The supply chain management applications 258 may facilitate adherence to production plans and on-time delivery of products and services.

Third-party applications 260, as well as legacy applications 262, may be integrated with domain applications 134 and utilize cross-functional services 132 on the enterprise application platform 112.

Additionally, collaborative applications 264 may facilitate joint creation and modification of documents and other work product by multiple users, and data management applications 266 may enable data organization and other management functions to be performed on data generated by one or more other domain applications 134.

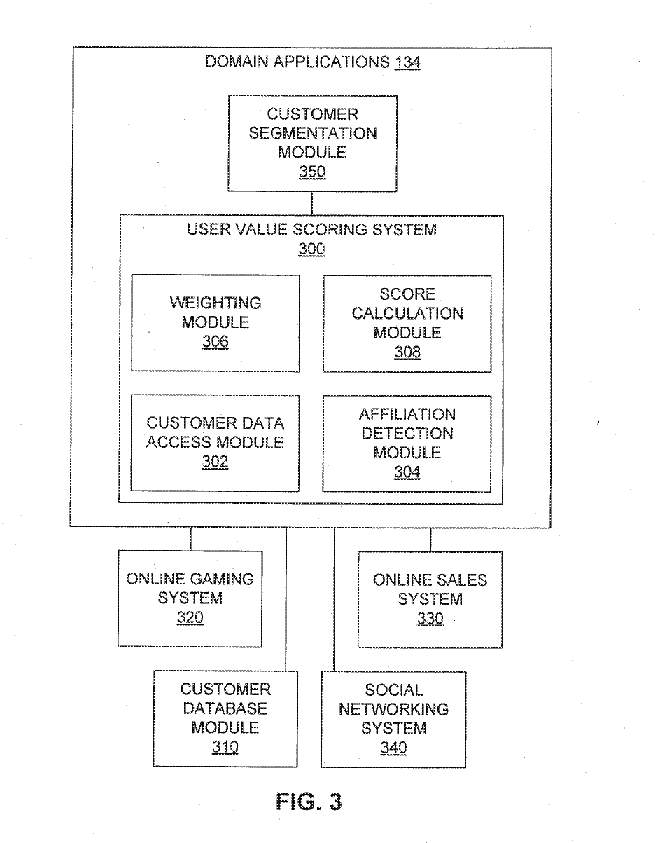

FIG. 3 is a block diagram of example modules employable as domain applications 134 of the enterprise application platform 112 of FIG. 1 for systems and methods of user or customer value scoring using social contact information. More specifically, the domain applications 134 may include a user value scoring system 300, which may further include a customer data access module 302, an affiliation detection module 304, a weighting module 306, and a score calculation module 308. While each of these modules 302-308 are shown as distinct modules all serving within the domain applications 134 of the enterprise application platform 112, other examples may be combined into fewer modules or separated into a greater number of modules. Further, one or more of the modules 302-308 may reside outside the enterprise application platform 112 while still performing the corresponding functions discussed below.

As discussed below, the data retrieved and generated by the user value scoring system 300 may be related to a particular online commerce system. Examples of an online commerce system, as depicted in FIG. 3, may include an online sales system 330 through which multiple customers may purchase products and services online. The products and services may be offered as retail products and services offered at specified prices, or may be offered by way of a bidding system. In other implementations, the online commerce system may be a system not primarily directed to the sales of products and services, but yet may facilitate the purchase of real or virtual products and services by patrons of the system. A specific example of this type of system is an online gaming system 320, which may offer virtual goods or assets to be employed in one or more online games by the purchaser. While the online gaming system 320 and the online sales system 330 are shown as being located external to the domain applications 134 (and possibly external to the enterprise application platform 112 of FIG. 1, as well), the online gaming system 320 and/or the online sales system 330 may be provided by one or more domain applications 134 in other implementations.

The customer data access module 302 may access and retrieve data for a user or customer describing activities of the user with respect to an online commerce system. In the example of FIG. 3, the customer data access module 302 retrieves this data from a customer database module 310 associated with the online commerce system. The customer database module 310 may be at least a portion of the database 130 of FIG. 1, accessible via one or more database servers 128 of the enterprise application platform 112, although other locations for the customer database module 310 are also possible. In one example, the user or customer activities described in the data accessed via the customer data access module 302 may be data describing purchases of products or services provided by the online commerce system that were made by the user or customer. Such information may include, in one implementation, the amount of money each user has spent on the products and services, possibly along with timing information indicating when the purchases were made. In other examples, the customer data access module 302 may retrieve other data or measurements of customer or user activities associated with the online customer system.

The affiliation detection module 304 may detect or determine one or more people that are affiliated with a particular user or customer of the online commerce system. In one example, the affiliation detection module 304 accesses a social networking system 340 to identify friends of a particular user. In this case, the social networking system 340 may be an online system primarily dedicated to social networking, such as Facebook® and Myspace®. As a result, one or more of the friends identified via the social networking system 340 may not necessarily be users or customers of the online commerce system.

In other implementations, the social networking system 340 may be coupled with, or be an integrated part of, the online commerce system, such as the online gaming system 320 or the online sales system 330. Under these circumstances, the people identified by the affiliation detection module 304 as being affiliated with the particular user are likely to be users of the associated online commerce system. In addition, in some implementations, the identified affiliations of a user may possess some relationship with the particular user whose score is to be generated within the online commerce system. In the embodiment of the online gaming system 320, the identified affiliations may be users that have a relationship with the particular user. For example, the identified users may be in the same gaming party or group with the particular user, or may be identified as friends of the particular user specifically within the context of the online gaming system 320. In another implementation, users for whom the particular user serves in a kind of leadership role, such as the head of a group or party within the online gaming system 320, may be identified as the affiliated users. In at least some of these implementations, the user may be considered to have some influence over the purchase decisions of the affiliated users.

After the people affiliated with the particular user are identified, the user value scoring system 300 may then utilize the customer data access module 302 to access customer data for each of the identified individuals. As is described more fully below, this customer data may also be employed to generate the user value score for the particular user.

In some implementations, the affiliation detection module 304 may access or retrieve data indicating a relationship strength between the particular user for which a value score is being calculated and other users affiliated with the particular user. More specifically, the affiliation detection module 304 may retrieve information quantifying a number of interactions between the particular user and another person for each of a number of different types of interactions. In one implementation, these interactions may take place through a system especially adapted for social networking, such as the social networking system 340. In this case, examples of the interactions may include messages transmitted or passed between the particular user and people affiliated with that user, passing of content between the particular user and the affiliations of the user, wall postings between the parties, comments provided between the particular user and others, and the like.

In another implementation, the affiliation detection module 304 may retrieve information regarding the number and type of interactions between parties that occur through the online commerce system, such as the online gaming system 320 or the online sales system 330. Examples of these interactions may include, but are not limited to, a number of times the particular user and an affiliated user worked toward the same task or goal in an online game, the number of times the particular user and the affiliated user joined the same player group or unit within the online game, the amount of time the particular user and the affiliated user were part of the same player group unit, and so on.

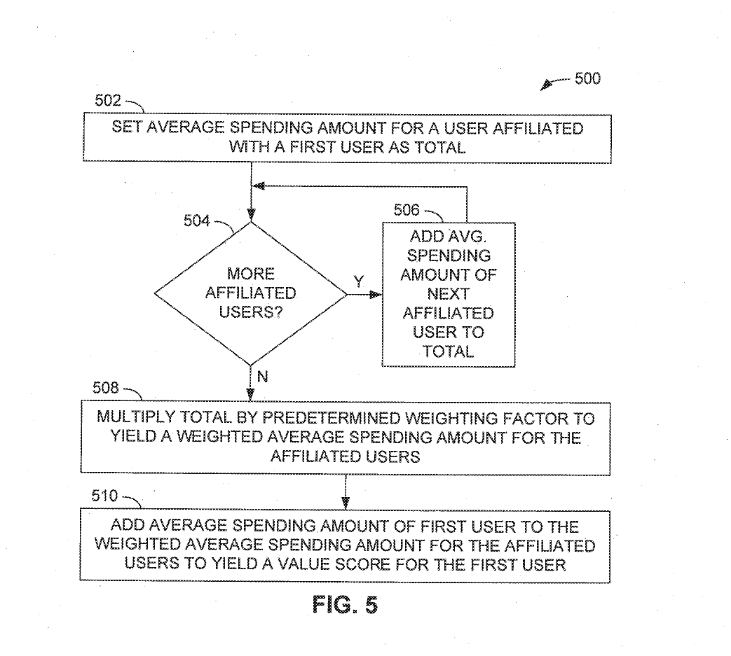

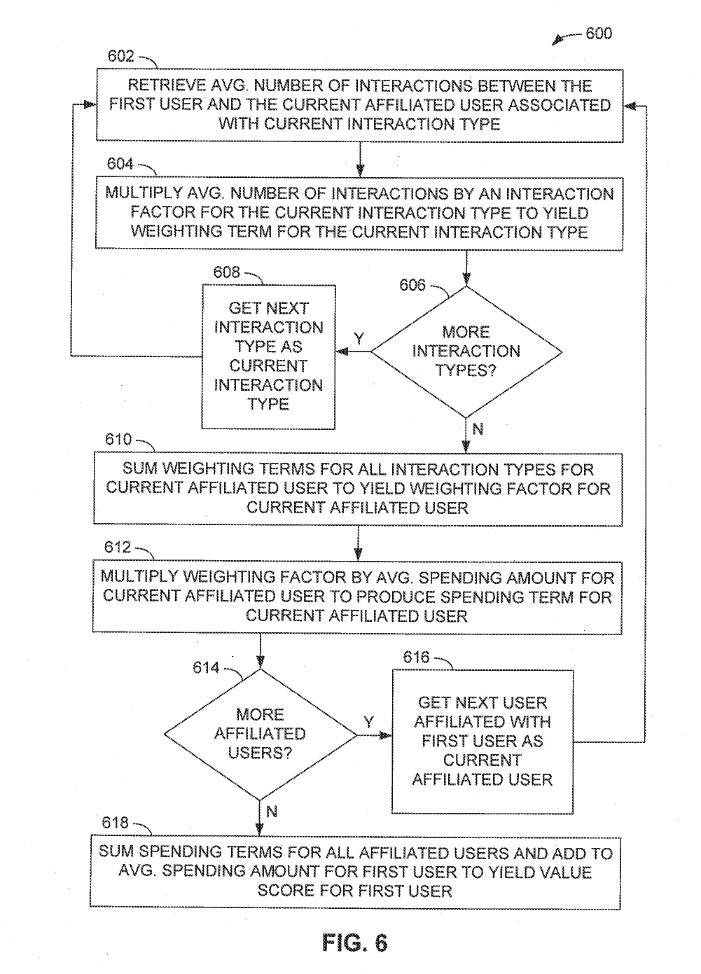

The weighting module 306 may receive at least some of the data retrieved by the customer data access module 302 and/or the affiliation detection module 304 and weight that data according to some formula or algorithm, thus preparing that data for use in calculating a user value score. In one example, purchase data (e.g., an amount of money spent via the online commerce system over a predefined period of time) for each of the users affiliated with the particular user for whom the value score is being generated may be weighted by some factor, such as a predetermined weighting factor, in preparation for combining the weighted data with purchase data of the particular user. In another example, the weighting factor may be a value calculated from interaction data provided by the affiliation detection module 304. Such weighting examples are more completely described below in conjunction with FIGS. 5 and 6. In yet other examples, any combination of data accessed via the customer data access module 302 and the affiliation detection module 304 that relates to the particular user, the people affiliated with the particular user, or both may be weighted and serve as a basis for calculation of the user value score for the particular user.

The score calculation module 308 may receive the weighted data from the weighting module 306 and combine that data with information regarding the value of the particular user being scored to generate the user value score for the particular user. In one example, more specifically described below in conjunction with FIGS. 5 and 6, an amount of money spent by the particular user over some predetermined time period is added to the weighted data received from the weighting module 306 to calculate the user value score for the particular user. The score calculation module 308 may employ other methods for generating the user value score using data pertaining to the particular user and other users affiliated with the particular user in other embodiments.

In one implementation, the user value scoring system 300 may generate user value scores for any or all of the users of the online commerce system of interest. Once these user value scores are generated, a customer segmentation module 350 may employ these scores to apportion the users among multiple customer or market segments based on their value to the online commerce system. Accordingly, the online commerce system may direct various promotional and/or advertising activities to users identified with specific customer segments. For example, users associated with relatively high-value scores may be the target of ongoing promotional activities designed to persuade the users to maintain their purchasing levels with the online commerce system. In other examples, the online commerce system may direct one-time enticements to lower-value users to encourage a higher level of involvement with the online commerce system.

At least some of the modules 302-308 of the user value scoring system 300 may serve as domain applications 134 illustrated in FIG. 2. For example, the modules 302-308 of the user value scoring system 300, either collectively or individually, in addition to the customer segmentation module 350, may be viewed as one or more of the customer relationship management applications 250 described above to direct at least some of the customer relationship activities associated with the online commerce system.

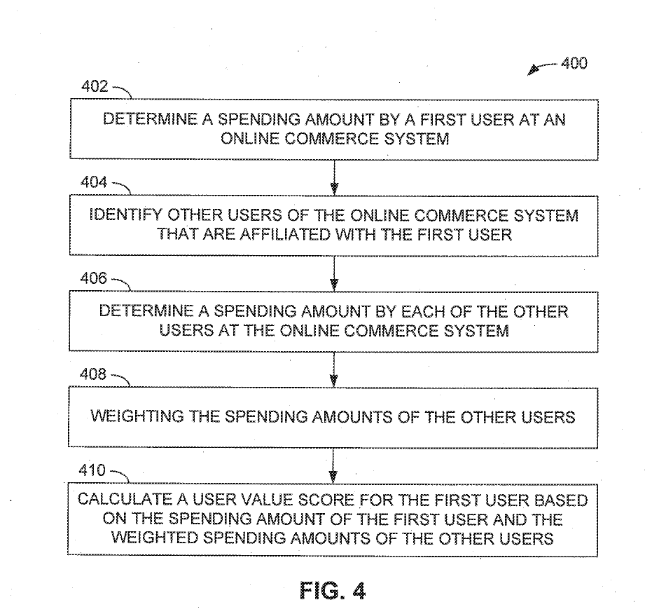

FIG. 4 is a flow diagram of an example method 400 of generating a user value score for a user of an online commerce system. One possible system for performing the method 400 is the user value scoring system 300 of FIG. 3. As a result, the method 400 is described below as being executed via the user value scoring system 300, although other systems may also be employed to the same end. In the method 400, the customer data access module 302 may determine a spending amount by a first user at an online commerce system by accessing the customer database module 310 for the online commerce system (operation 402). The affiliation detection module 304 may identify other users of the online commerce system that are affiliated with the first user (operation 404). As mentioned above, these users may be identified via a social networking system 340 that may or may not be coupled or associated with the online commerce system, or by way of the online commerce system itself, such as the online gaming system 320 or the online sales system 330.

Based on identifying the other users, the customer data access module 302 may determine a spending amount by each of the other users at the online commerce system (operation 406). The weighting module 306 may then weight the spending amounts of the other users (operation 408). This weighting may be performed in a number of ways, such as by way of a predetermined weighting factor, by use of a calculated weighting factor that considers the nature, number, and possibly other qualities of interactions between the identified affiliated users and the first user, or via some other method. The score calculation module 308 may then calculate a user value score for the first user based on the spending amount of the first user and the weighted spending amounts of the other users (operation 410). The generation of the user value score may be performed for any number of the users of the online commerce system, allowing the customer segmentation module 350 to associate each of the users with a specific market segment identified with a range of user value scores.

While the operations 402 through 410 of the method 400 of FIG. 4 are shown in a specific order, other orders of operation, including possibly concurrent or continual execution of at least portions of one or more operations, may be possible in some implementations of method 400, as well as other methods discussed herein.

FIG. 5 is a flow diagram illustrating an example method 500 of calculating the user value score for a first user based on average spending amounts associated with the first user and other users affiliated with the first user. Generally, operations 502 through 510 serve as the weighting operation 408 and the calculating operation 410 of the method 400 of FIG. 4. Further, method 500 presents just one of many possible methods for calculating a user value score as contemplated herein.

In the method 500, the weighting module 306 (FIG. 3) may set an average spending amount for a user affiliated with the first user as a total spending amount for affiliated users (operation 502). In one example, the average spending amount may be the average amount the affiliated user spends for real and/or virtual goods and services via the online commerce website in the course of some predetermined time period, such as a week, month, or year. If more affiliated users remain to be processed (operation 504), the average spending amount of the next affiliated user may be added to the total (operation 506). If no more affiliated users exist (operation 504), the resulting total represents the average amount of money spent collectively by the affiliated users via the online commerce system over the predetermined time period.

The weighting module 306 may then multiply the total average spending by the affiliated users by a predetermined weighting factor to yield a weighted average spending amount for the affiliated users (operation 508). In one example, the predetermined weighting factor may be some value less than one (e.g., 0.5) since the amount of money spent by users affiliated with the first user may be viewed as being only partially due to the influence of the first user, whether as a friend, a fellow game-player, or in some other capacity. The average spending amount of the first user may then be added to the weighted average spending amount of the affiliated users to produce a value score for the first user (operation 510). The resulting value score as described in the method 500 of FIG. 5 may be expressed by the following equation:

Score(User₀)=AvgSpendAmt(User₀)+(WgtFactor×Σᵢ₌₁ⁿ AvgSpendAmt(Userᵢ))

In this equation, Score is the value score being calculated, User₀ is the user (i.e., the first user) for whom the value score is being calculated, each Userᵢ is one of the n users affiliated with User₀, AvgSpendAmt is the average spending amount for the associated user, and WgtFactor is the predetermined weighting factor described above. As a result, the score for a first user includes not only a value to the online commerce system resulting directly from the first user, but also at least a portion of the value provided by other users that are affiliated with the first user.

FIG. 6 is a flow diagram illustrating an example method 600 of calculating the user value score for a first user based on average spending amounts associated with, and interactions between, the first user and other users affiliated with the first user. In the method 600, for one of the users affiliated with the first user, the affiliation detection module 304 (FIG. 3) retrieves an average number of interactions over some predetermined time period between the first user and the affiliated user for a particular interaction type (operation 602). As mentioned above, any of a number of possible interaction types may be taken into consideration in the method 600. Such interactions may include, for example, interactions facilitated via the social networking system 340 (e.g., messages, wall postings, comments, “likes,” and so on.) and/or interactions occurring via the online commerce system (e.g., engaging in a gaming task or quest together, joining the same gaming party or guild, and the like). In some examples, a quality or level of interaction may be considered in lieu of, or in addition to, the number of interactions for the interaction type.

The weighting module 306 may then multiply the retrieved average number of interactions by an interaction factor for the current interaction type to yield a weighting term for the current interaction type and current affiliated user (operation 604). In one example, the interaction factor may be a predefined value associated specifically with the current interaction type. In another implementation, the interaction factor may be the same for two or more of the interaction types. If more interaction types are to be processed (operation 606), the affiliation detection module 304 may determine the next interaction type to be processed for the current affiliated user (operation 608), resulting in that interaction type being processed in operations 602 and 604, as described above. This process may continue until all interactions types for the current affiliated user are processed.

If no more interaction types for the current affiliated user remain to be processed (operation 606), the weighting module 306 sums the weighting term for each interaction type of the current affiliated user to produce a weighting factor for the current affiliated user (operation 610). This weighting factor may be viewed as serving a role similar to that of the weighting factor described in the method 500 of FIG. 5, except that each affiliated user may be associated with a unique weighting factor. Accordingly, the weighting module 306 multiplies the weighting factor for the current affiliated user by the average spending amount for the current affiliated user through the online commerce system to produce a spending term for the current affiliated user (operation 612).

The affiliation detection module 304 may then determine if more users affiliated with the first user are available for processing (operation 614). If so, the affiliation detection module 304 may pass the identity of the next affiliated user to the customer data access module 302 and the weighting module 306 to produce a spending term for the current affiliated user via operations 602 through 612 (operation 616). Once all pertinent affiliated users have been processed (operation 614), the score calculation module 308 may then sum the generated spending terms for all of the affiliated users and add the average spending amount for the first user retrieved by the customer data access module 302 to yield the value score for the first user (operation 618). The resulting value score as described in the method 600 of FIG. 6 may be expressed by the following equation:

Score(User₀)=AvgSpendAmt(User₀)+Σᵢ₌₁ⁿ(Σⱼ₌₁ⁿ(IntNum_{i,j}×IntFactorⱼ)×AvgSpendAmt(Userᵢ))

In this equation, Score is the value score being calculated, User₀ is the user (i.e., the first user) for whom the value score is being calculated, each Userᵢ is one of the n users affiliated with User₀, AvgSpendAmt is the average spending amount for the associated user, IntNum_{i,j} is the number of interactions between the first user and Userᵢ for interaction type j, and IntFactorⱼ is the interaction factor for interaction type j. Thus, in this particular method 600, the score for a first user includes not only a value to the online commerce system resulting directly from the first user, but also at least a portion of the value provided by other users that are affiliated with the first user. In addition, the value provided by the other users is adjusted based on interactions or connections between that user and the first user.

In both methods 500 and 600 described above, a first user that does not spend anything through the online commerce system may still be of value to the online commerce system by virtue of what the users affiliated with the first user (e.g., friends, gaming companions, and so on) spend. In addition, the number of affiliated friends, the amount of money they spend at the online commerce system, and possibly the quantity and/or quality of the interactions between the first user and the affiliated users may affect the overall value attributed to the first user.

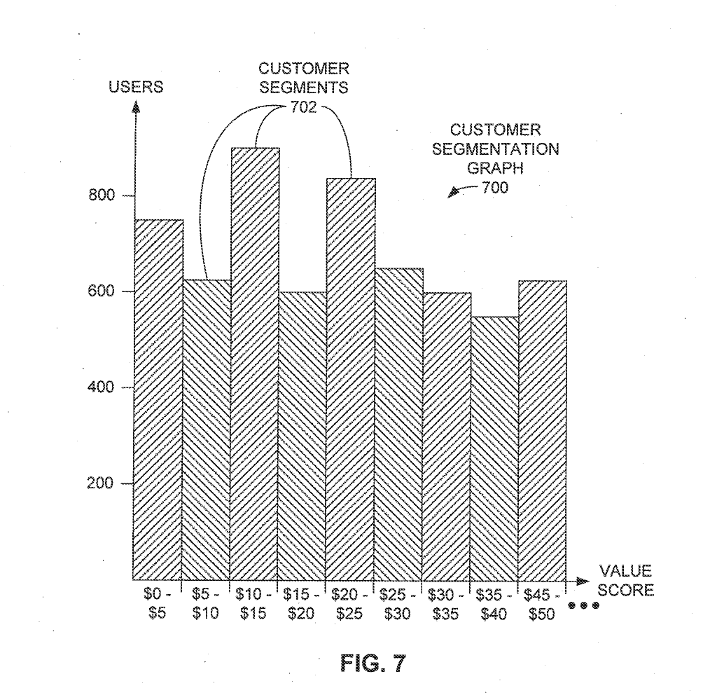

FIG. 7 is an example customer segmentation graph 700 depicting numbers of users versus user value scores, such as those scores calculated using the methods 500 and 600 of FIGS. 5 and 6. As a result of segmenting the user population of the online commerce system into multiple customer segments 702, a provider of the online commerce system may direct various advertising, promotional, and related activities to specific users based on the particular customer segment 702 in which they reside. In some examples, considering the spending of both a first user and the affiliated users of the first user aids in distributing users more evenly across a plurality of the customer segments 702. Such a distribution may be more beneficial or useful for customer segmentation purposes than considering only the spending of each user individual, which oftentimes results in a more uneven distribution, such as an exponential distribution in which many users are identified with small spending amounts, while only a few are associated with much larger spending amounts.

As a result of at least some of the embodiments described above, user scores indicating a value of a user with respect to an online commerce system, such as an online sales system or an online gaming system, are generated. The scores may take into account the spending amounts of both the user for whom the score is being generated and the users affiliated with that user. Further, in the calculation of the value score for a first user, the spending amounts of the affiliated users may be weighted relative to that of the first user by a weighting factor that is either predetermined or is based on a level of interaction between the first user and the affiliated users. The resulting user value scores for the users of the online commerce system may then be used to segment the users into different customer segments for advertising, promotional, and other business purposes.

While various embodiments discussed above emphasize an online sales system and an online gaming system as two examples of online commerce systems to which the embodiments are directed, other types of online commerce systems, such as weblogs, news websites, websites dedicated to specific topics, websites hosted by specific corporations, search engine websites, and the like may also benefit from application of the various principles discussed herein.

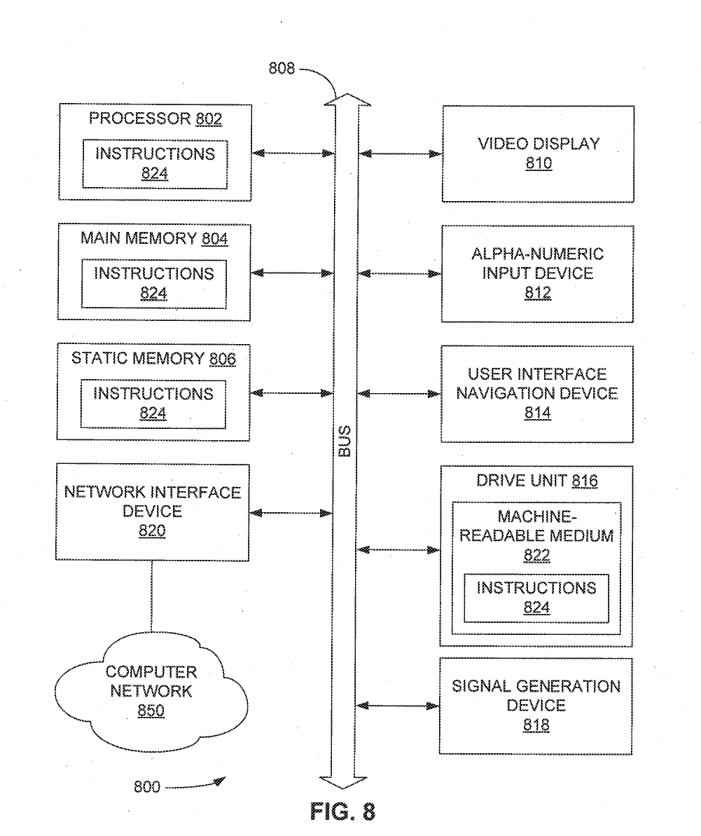

FIG. 8 depicts a block diagram of a machine in the example form of a processing system 800 within which may be executed a set of instructions 824 for causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment.

The machine is capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example of the processing system 800 includes a processor 802 (e.g., a central processing unit (CPU), a graphics processing unit (GPU), or both), a main memory 804 (e.g., random access memory), and static memory 806 (e.g., static random-access memory), which communicate with each other via bus 808. The processing system 800 may further include video display unit 810 (e.g., a plasma display, a liquid crystal display (LCD), or a cathode ray tube (CRT)). The processing system 800 also includes an alphanumeric input device 812 (e.g., a keyboard), a user interface (UI) navigation device 814 (e.g., a mouse), a disk drive unit 816, a signal generation device 818 (e.g., a speaker), and a network interface device 820.

The disk drive unit 816 (a type of non-volatile memory storage) includes a machine-readable medium 822 on which is stored one or more sets of data structures and instructions 824 (e.g., software) embodying or utilized by any one or more of the methodologies or functions described herein. The data structures and instructions 824 may also reside, completely or at least partially, within the main memory 804, the static memory 806, and/or within the processor 802 during execution thereof by processing system 800, with the main memory 804 and processor 802 also constituting machine-readable, tangible media.

The data structures and instructions 824 may further be transmitted or received over a computer network 850 via network interface device 820 utilizing any one of a number of well-known transfer protocols (e.g., HyperText Transfer Protocol (HTTP)).

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., the processing system 800) or one or more hardware modules of a computer system (e.g., a processor 802 or a group of processors) may be configured by software (e.g., an application or application portion) as a hardware module that operates to perform certain operations as described herein.

In various embodiments, a hardware module may be implemented mechanically or electronically. For example, a hardware module may include dedicated circuitry or logic that is permanently configured (for example, as a special-purpose processor, such as a field-programmable gate array (FPGA) or an application-specific integrated circuit (ASIC)) to perform certain operations. A hardware module may also include programmable logic or circuitry (for example, as encompassed within a general-purpose processor 802 or other programmable processor) that is temporarily configured by software to perform certain operations. It will be appreciated that the decision to implement a hardware module mechanically, in dedicated and permanently configured circuitry, or in temporarily configured circuitry (for example, configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules include a general-purpose processor 802 that is configured using software, the general-purpose processor 802 may be configured as respective different hardware modules at different times. Software may accordingly configure a processor 802, for example, to constitute a particular hardware module at one instance of time and to constitute a different hardware module at a different instance of time.

Modules can provide information to, and receive information from, other modules. For example, the described modules may be regarded as being communicatively coupled. Where multiples of such hardware modules exist contemporaneously, communications may be achieved through signal transmissions (such as, for example, over appropriate circuits and buses) that connect the modules. In embodiments in which multiple modules are configured or instantiated at different times, communications between such modules may be achieved, for example, through the storage and retrieval of information in memory structures to which the multiple modules have access. For example, one module may perform an operation and store the output of that operation in a memory device to which it is communicatively coupled. A further module may then, at a later time, access the memory device to retrieve and process the stored output. Modules may also initiate communications with input or output devices, and can operate on a resource (for example, a collection of information).

The various operations of example methods described herein may be performed, at least partially, by one or more processors 802 that are temporarily configured (e.g., by software) or permanently configured to perform the relevant operations. Whether temporarily or permanently configured, such processors 802 may constitute processor-implemented modules that operate to perform one or more operations or functions. The modules referred to herein may, in some example embodiments, include processor-implemented modules.

Similarly, the methods described herein may be at least partially processor-implemented. For example, at least some of the operations of a method may be performed by one or more processors 802 or processor-implemented modules. The performance of certain of the operations may be distributed among the one or more processors 802, not only residing within a single machine but deployed across a number of machines. In some example embodiments, the processors 802 may be located in a single location (e.g., within a home environment, within an office environment, or as a server farm), while in other embodiments, the processors 802 may be distributed across a number of locations.

While the embodiments are described with reference to various implementations and exploitations, it will be understood that these embodiments are illustrative and that the scope of claims provided below is not limited to the embodiments described herein. In general, the techniques described herein may be implemented with facilities consistent with any hardware system or hardware systems defined herein. Many variations, modifications, additions, and improvements are possible.

Plural instances may be provided for components, operations, or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the claims. In general, structures and functionality presented as separate components in the exemplary configurations may be implemented as a combined structure or component. Similarly, structures and functionality presented as a single component may be implemented as separate components. These and other variations, modifications, additions, and improvements fall within the scope of the claims and their equivalents.

What is claimed is:

1. A method, comprising:
determining a spending amount by a first user at an online commerce system;
identifying other users of the online commerce system that are affiliated with the first user;
determining a spending amount by each of the other users at the online commerce system;
weighting, using at least one processor of a machine, the spending amounts of the other users; and
calculating a user value score for the first user based on the spending amount of the first user and the weighted spending amounts of the other users.

2. The method of claim 1, the online commerce system comprising an online gaming system, the spending amount by the first user and the spending amount by each of the other users comprising a monetary amount spent on virtual goods employable in the online gaming system.

3. The method of claim 1, the online commerce system comprising an online sales system, the spending amount by the first user and the spending amount by each of the other users comprising a monetary amount spent on actual goods sold via the online sales system.

4. The method of claim 1, the first user being affiliated with at least one of the other users via a social networking system.

5. The method of claim 1, the first user being affiliated with at least one of the other users via a relationship within an online gaming system.

6. The method of claim 1, the weighting of the spending amounts of the other users comprising weighting each of the spending amounts of the other users by a predetermined weighting factor.

7. The method of claim 1, the weighting of the spending amounts of the other users comprising weighting each of the spending amounts of the other users by a weighting factor signifying a relationship strength between the first user and the other user corresponding to the weighting factor.

8. The method of claim 7, the weighting factor comprising a sum of weighting terms, each of the weighting terms comprising a number of interactions of an interaction type between the first user and the other user corresponding to the weighting factor, scaled by an interaction factor of the interaction type.

9. The method of claim 8, the interaction type comprising a social network communication between the first user and the other user corresponding to the weighting factor.

10. The method of claim 8, the interaction type comprising an interaction between the first user and the other user corresponding to the weighting factor via an online gaming system.

11. The method of claim 1, the calculating of the user value score comprising summing the spending amount of the first user and the weighted spending amounts of the other users.

12. The method of claim 1, further comprising identifying the first user as belonging to a predetermined customer segment related to the online commerce system based on the user value score.

13. A non-transitory computer-readable storage medium comprising instructions that, when executed by at least one processor of a machine, cause the machine to perform operations comprising:
determining a spending amount by a first user at an online commerce system;
identifying other users of the online commerce system that are affiliated with the first user;
determining a spending amount by each of the other users at the online commerce system;
weighting the spending amounts of the other users; and
calculating a user value score for the first user based on the spending amount of the first user and the weighted spending amounts of the other users.

14. A system comprising:
an affiliation detection module to identify other users of an online commerce system that are affiliated with a first user of the online commerce system;
a customer data access module to determine a spending amount by the first user at the online commerce system and to determine a spending amount by each of the other users at the online commerce system;
a weighting module to weight the spending amounts of the other users; and
a score calculation module to calculate a user value score for the first user based on the spending amount of the first user and the weighted spending amounts of the other users.

15. The system of claim 14, the first user being affiliated with at least one of the other users via a social networking system.

16. The system of claim 14, the first user being affiliated with at least one of the other users via a relationship within an online gaming system.

17. The system of claim 14, the weighting module to weight each of the spending amounts of the other users by a predetermined weighting factor.

18. The system of claim 14, the weighting module to weight each of the spending amounts of the other users by a weighting factor signifying a relationship strength between the first user and the other user corresponding to the weighting factor.

19. The system of claim 18, the weighting factor comprising a sum of weighting terms, each of the weighting terms related to one of a plurality of interaction types between the first user and the other user corresponding to the weighting factor, the affiliation detection module to access a number of interactions of each of the plurality of interaction types, the corresponding weighting term comprising the number of interactions of the corresponding interaction type scaled by an interaction factor of the corresponding interaction type.

20. The system of claim 14, further comprising a customer segmentation module to identify the first user as belonging to a predetermined customer segment related to the online commerce system based on the user value score.
